(19) United States
(12) Patent Application Publication
(10) Pub. No.: US 2026/0062513 A1
(43) Pub. Date: Mar. 5, 2026

(54) LIQUID CRYSTAL POLYMER PARTICLE, MANUFACTURING METHOD THEREOF AND POLYIMIDE FILM USING THE SAME

(71) Applicant: TAIMIDE TECHNOLOGY INCORPORATION, Hsinchu Hsien (TW)

(72) Inventors: CHIA-LIANG TSAI, Hsinchu Hsien (TW); YUN-HSIANG CHANG, Hsinchu Hsien (TW); CHUN-TING LAI, Hsinchu Hsien (TW); YI-HSUEH HO, Hsinchu Hsien (TW)

(73) Assignee: TAIMIDE TECHNOLOGY INCORPORATION, Hsinchu Hsien (TW)

(21) Appl. No.: 18/823,726

(22) Filed: Sep. 4, 2024

(51) Int. Cl. C08G 63/06; C08G 63/87; C09D 167/04; C09D 179/08

(52) U.S. Cl. CPC C08G 63/065; C08G 63/87; C09D 167/04; C09D 179/08

(57) ABSTRACT

Provide a liquid crystal polymer particle, a manufacturing method thereof, and a polyimide film using the particle. The manufacturing method comprises the following steps: providing a compound monomer having a chemical structural formula of COOH—Ar—OH, wherein Ar is at least one conjugated cyclic structure; adding the compound monomer to a solvent with a boiling point of 100° C. or above, and heating to the boiling point of the solvent for performing an acetylation reaction to obtain a first product; adding a catalyst to the first product to perform a transesterification reaction for obtaining a second product; performing a solid-state polymerization of the second product at a temperature of 200-250° C. to obtain the liquid crystal polymer particle, a particle size distribution of which has a cumulative particle size at 50% (D50) of 1.5 um or less and a cumulative particle size at 99% (D99) of 10 um or less.

### BACKGROUND OF THE INVENTION

### 1. Field of the Invention

The present disclosure related to a liquid crystal polymer particle, a manufacturing method thereof, and a polyimide film using the liquid crystal polymer particle, and in particular to forming the liquid crystal polymer particle in a polymerization manner and a polyimide film using the liquid crystal polymer particle.

### 2. Description of the Related Art

With the advent of the 5G era, the market has noticed that the liquid crystal polymer (LCP) has high rigidity and high electrical stability, allowing it to maintain good characteristics in high-frequency environments. Therefore, attempts have been made to use it as a flexible board material. The liquid crystal polymer particles have also been mixed into composite films. For example, patent documents TW202112889A and TW202246393A have described applications in related fields.

### BRIEF SUMMARY OF THE INVENTION

However, as mentioned in the patent documents mentioned above, the conventional manufacturing method of liquid crystal polymer is to react it with hydroxycarboxylic acid, aromatic dicarboxylic acid and diol in two stages: melt polycondensation and solid phase polymerization. The reaction needs to be completed in a temperature range of 200 to 350° C., and the melting point of the liquid crystal polymer produced is less than 320° C. If it is desired to produce a liquid crystal polymer with a higher melting point, it will inevitably need a higher reaction temperature, which will require high-temperature resistance on the production equipment, otherwise it will easily cause damage to the equipment. Moreover, the liquid crystal polymer produced by the above method must go through multiple steps such as crushing, grinding, and sieving to obtain liquid crystal polymer particles of the required particle size, which is not only labor-intensive and time-consuming but also increases costs.

However, in the currently common knowledge field, there is no use of a different method from melt polycondensation to complete the liquid crystal polymer reaction or the liquid crystal polymer reaction is not completed in the temperature range below 200˜350° C., and there is no mention that liquid crystal polymer particle with a small particle size can be produced without the use of multiple steps, such as crushing, grinding, sieving, etc.

In view of the above, there is still room for improvement in the existing techniques for liquid crystal polymer particles and their manufacturing methods.

The present disclosure relates to a liquid crystal polymer particle, a manufacturing method thereof, and a polyimide film using the liquid crystal polymer particle. The manufacturing method includes the following steps: providing a compound monomer having a chemical structural formula of COOH—Ar—OH, wherein the compound monomer includes a structural unit having at least a conjugated cyclic structure (Ar), a carboxylic acid (COOH) and an alcohol (OH); adding the compound monomer to a solvent with a boiling point of 100° C. or above, and heating to the boiling point of the solvent for performing an acetylation reaction to obtain a first product; adding a catalyst to the first product to perform a transesterification reaction for obtaining a second product; performing a solid-state polymerization of the second product at a temperature of 200-250° C. to obtain the liquid crystal polymer particle; wherein a particle size distribution of the liquid crystal polymer particle has a cumulative particle size at 50% (D50) of 1.5 μm or less and a cumulative particle size at 99% (D99) of 10 um or less.

The liquid crystal polymer particle is polymerized from a compound monomer. The liquid crystal polymer particle includes at least one conjugated cyclic structure (Ar), which has a chemical structural formula of

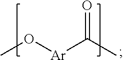

and
a particle size distribution of the particle has a cumulative particle size at 50% (D50) of 1.5 um or less and a cumulative particle size at 99% (D99) of 10 um or less.

The polyimide film includes the liquid crystal polymer particle. A content of the liquid crystal polymer particle is 5˜70 wt % of the polyimide film, and a surface roughness (Sa) of the polyimide film is 0.8 um or less.

### DETAILED DESCRIPTION OF THE INVENTION

The present disclosure relates to a liquid crystal polymer particle, a manufacturing method thereof, and a polyimide film using the liquid crystal polymer particle. The manufacturing method of the liquid crystal polymer particle includes the following steps: providing a compound monomer having a chemical structural formula of COOH—Ar—OH, wherein the compound monomer includes a structural unit having at least a conjugated cyclic structure (Ar), a carboxylic acid (COOH) and an alcohol (OH); adding the compound monomer to a solvent with a boiling point of 100° C. or above, and heating to the boiling point of the solvent for performing an acetylation reaction to obtain a first product; adding a catalyst to the first product to perform a transesterification reaction, obtaining a second product; performing a solid-state polymerization of the second product at a temperature of 200-250° C. to obtain the liquid crystal polymer particle; wherein a particle size distribution of the liquid crystal polymer particle has a cumulative particle size at 50% (D50) of 1.5 um or less and a cumulative particle size at 99% (D99) of 10 um or less.

The liquid crystal polymer particle is polymerized from a compound monomer. The liquid crystal polymer particle includes at least one conjugated cyclic structure (Ar), which has a chemical structural formula of

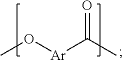

and
the particle size distribution of the particle has a cumulative particle size at 50% (D50) of 1.5 um or less and a cumulative particle size at 99% (D99) of 10 um or less.

The polyimide film includes the liquid crystal polymer particle. A content of the liquid crystal polymer particle is 5˜70 wt % of the polyimide film, and a surface roughness (Sa) of the polyimide film is 0.8 um or less.

The liquid crystal polymer is composed of more than one structural unit containing at least a conjugated cyclic structure, a carboxylic acid and an alcohol compound. The solvent method is to carry out the polymerization reaction by placing the above-mentioned compound monomer in a solvent, heating it until the solvent boils and vaporizes, then condenses it through a reflux tube and then refluxes it into the reactor to dissolve the compound monomer. After the polymerization reaction, liquid crystal polymer particles will precipitate, and liquid crystal polymer particles can be obtained by filtering and drying excess solvent. Afterwards, the liquid crystal polymer particles are tested for various properties, such as particle size, melting point, cracking temperature, etc.

The above-mentioned compound monomer may be at least one of the following: 6-hydroxynaphthalene-2-carboxylic acid (HNA), 4-hydroxybenzoic acid (HBA), 4′-hydroxy-[1,1′-biphenyl]-4-carboxylic acid (HBPA), 6-hydroxypyridine-3-carboxylic acid (HPA), 4-hydroxy-2-methylbenzoic acid (HMA), 6-hydroxyanthracene-2-carboxylic acid (HAA), 7-hydroxypyrene-2-carboxylic acid (HPYA) and the like.

The solvent is an aprotic solvent and the boiling point of the solvent is above 100° C., preferably above 130° C. The solvent may be at least one of the following: dimethylacetamide (DMAc), dimethylformamide (DMF), dimethylbenzene (Xylene), 1,4-dimethylbenzene (p-Xylene), 1,3-dimethylbenzene (m-Xylene), 1,2-dimethylbenzene (o-Xylene), 3-methylpyridine (3MP), 1-Methyl-2-pyrrolidone (NMP), etc.

After adding the catalyst and performing transesterification, the polymerization reaction forms liquid crystal polymer particles, and the catalyst may be at least one of the following nitrogen-containing organic catalysts: imidazole, 1-methylimidazole, 2-methylimidazole, 1,2-dimethylimidazole, 1,4-diazabicyclo[2.2.2]octane (DBUCA), 1,8-diazabicyclo[5.4.0]-7-undecene (DBU), and 1,5-diazabicyclo[4.3.0]non-5-ene (DBN).

The liquid crystal polymer particles formed in the solvent are subjected to filtering, drying and other steps to remove the solvent, and finally undergo a solid-state polymerization reaction in a vacuum environment and are baked at a temperature of 200-250° C. for more than 5 hours to obtain the liquid crystal polymer particles with high molecular weight.

The melting point of the liquid crystal polymer particles obtained by using the manufacturing method is above 300° C., the thermal cracking temperature when the thermogravimetric loss is 1 wt % is above 470° C. Further, the particle size distribution of the liquid crystal polymer particles has a cumulative particle size at 50% (D50) of 1.5 um or less and a cumulative particle size at 99% (D99) of 10 um or less.

In addition, because the particle size of the liquid crystal polymer particles produced is small, the film thickness of the polyimide film using the liquid crystal polymer particles is 25 um or less. The content of the liquid crystal polymer particles is 5˜70 wt % of the polyimide film, and the surface roughness (Sa) of the polyimide film is less than 0.8 um.

The reaction of the first stage is to add the compound monomer to the acetic anhydride at a dosage (molar ratio) of 1:4 and to react at 150-160° C. for more than 4 hours to complete the acetylation reaction, and then the solution is precipitated in water. Finally, the precipitate is filtered and dried to obtain the first product (monomer after acetylation).

For the reaction of the second stage, the above-mentioned first product and the catalyst are added into the solvent to react at the boiling point of the solvent for more than 6 hours for performing the transesterification reaction. After the reaction is completed, it will precipitate in the solvent due to poor solubility. After filtering and drying, the second product (liquid crystal polymer particles with small particle size before solid-state polymerization) can be obtained.

Finally, the second product is subjected to solid-state polymerization by baking at 200-250° C. under vacuum to obtain liquid crystal polymer particles.

The polyimide film is prepared by a chemical cyclization method, which is carried out by adding a dehydrating agent and a catalyst, wherein the dehydrating agent is acetic anhydride, and the catalyst is methylpyridine and isoquinoline.

The addition amount of the dehydrating agent is at least 2 equivalents or more of the polyamic acid, and the addition amount of the catalyst is at least 1 equivalent or more of the polyamic acid.

As to the preparation of the polyimide film, the liquid crystal polymer particles and polyamic acid are blended in a certain proportion, and then the dehydrating agent and the catalyst are added and stirred evenly, followed by coating on the glass after degassing and heating in an oven at 80° C. to remove most of the solvent, thereby obtaining a polyamic gel film. After that, the above-mentioned polyamic gel film is heated in an oven at 170° C. to 370° C. to form a polyimide film. The polyimide film is then tested for surface roughness (Sa).

Polyamic acid is a commonly known polyimide precursor that is usually formed by condensation polymerization of diamine and dianhydride in a solvent, which will not be described again herein.

In particular, the liquid crystal polymer particles account for 5˜70 wt % of the polyimide film.

### EXAMPLES

### <Testing Method>

The characteristics of the liquid crystal polymer particles obtained in the following examples and the polyimide film using the liquid crystal polymer particles are measured using the following method.
(1) Melting point: A differential scanning calorimetry (DSC) is used to measure the melting point (Tm). The model number is: TA Instruments Model 2920. Measurement method: About 5 mg of the sample are placed in an aluminum weighing pan, pressed into a sheet to form a sample to be measured, and measured from room temperature to 450° C. at a rate of 10° C./min under nitrogen atmosphere with a flow rate of 40 mL/min.
(2) Thermogravimetric loss: A thermogravimetric analyzer (TGA) is used to measure the thermogravimetric loss at 1 wt %. The model number is: TA Instrument Model 2050. Measurement method: 5-10 mg of the sample are placed into a platinum weighing pan and heated from room temperature to 120° C. at a rate of 10° C./min under nitrogen with a flow rate of 110 mL/min, and then the temperature is kept for 5 minutes to remove the water, followed by raising the temperature to 800° C. to determine the weight loss caused by thermal decomposition of the sample during the heating process.
(3) Particle size: A dynamic light scattering (DLS) particle size analyzer is used to measure the particle size, as well as the particle size distribution of D50 and D99. The model number is: Malvern Zetasizer Nano ZS90. Measurement method: DMAc is used to dilute the sample to about 0.1 wt %, and then an appropriate amount of the sample is dropped into the instrument for cyclic measurement.
(4) Surface roughness (Sa): A white light interferometry (WLI) is used to measure the surface roughness (Sa). The model number is: ZYGO Newview 8300. Measurement method: the sample is cut into appropriate size and then subjected to surface analysis.

### Example 1

As described in the detailed description, HNA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 28%.

### Example 2

As described in the detailed description, 85 mol % HNA/15 mol % HBA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 25%.

### Example 3

As described in the detailed description, 75 mol % HNA/25 mol % HBA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 24%.

### Example 4

As described in the detailed description, HBA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 29%.

### Example 5

As described in the detailed description, 15 mol % HNA/85 mol % HBA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 26%.

### Example 6

As described in the detailed description, 25 mol % HNA/75 mol % HBA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 25%.

### Example 7

As described in the detailed description, 75 mol % HNA/25 mol % HBPA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 27%.

### Example 8

As described in the detailed description, 75 mol % HBA/25 mol % HBPA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 25%.

### Example 9

As described in the detailed description, HNA was selected as the compound monomer. The first product obtained after the acetylation of the first stage was 2 g; the solvent was 8 g of NMP, and the boiling point of the solvent was 202° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 29%.

### Example 10

As described in the detailed description, HNA was selected as the compound monomer. The first product obtained after the acetylation of the first stage was 2 g; the solvent was 8 g of 3MP, and the boiling point of the solvent was 144° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 21%.

### Example 11

As described in the detailed description, HNA was selected as the compound monomer. The first product obtained after the acetylation of the first stage was 2 g; the solvent was 8 g of DMAc, and the boiling point of the solvent was 165° C. The catalyst in the second stage was 1-methylimidazole, the catalyst dosage was 10.3 mol % of the total moles of the compound monomer, and the boiling point of the catalyst was 198° C. Finally, through solid-state polymerization at 230° C., the yield was 24%.

### Example 12

As described in the detailed description, HNA was selected as the compound monomer. The first product obtained after the acetylation of the first stage was 2 g; the solvent was 8 g of DMAc, and the boiling point of the solvent was 165° C. The catalyst in the second stage was 2-methylimidazole, the catalyst dosage was 10.3 mol % of the total moles of the compound monomer, and the boiling point of the catalyst was 268° C. Finally, through solid-state polymerization at 230° C., the yield was 28%.

### Example 13

As described in the detailed description, HNA was selected as the compound monomer. The first product obtained after the acetylation of the first stage was 2 g; the solvent was 8 g of DMAc, and the boiling point of the solvent was 165° C. The catalyst in the second stage was 1,2-dimethylimidazole, the catalyst dosage was 10.3 mol % of the total moles of the compound monomer, and the boiling point of the catalyst was 204° C. Finally, through solid-state polymerization at 230° C., the yield was 26%.

### Example 14

As described in the detailed description, HNA was selected as the compound monomer. The first product obtained after the acetylation of the first stage was 2 g; the solvent was 8 g of DMAc, and the boiling point of the solvent was 165° C. The catalyst in the second stage was 1,4-diazabicyclo[2.2.2]octane (DBUCA), the catalyst dosage was 10.3 mol % of the total moles of the compound monomer, and the boiling point of the catalyst was 175° C. Finally, through solid-state polymerization at 230° C., the yield was 22%.

### Comparative Example 1

As described in the detailed description, 65 mol % HNA/35 mol % HBA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 26%.

### Comparative Example 2

As described in the detailed description, 50 mol % HNA/50 mol % HBA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 27%.

### Comparative Example 3

As described in the detailed description, 65 mol % HNA/35 mol % HBPA was selected as the compound monomer. The first product obtained after the acetylation of the first stage was 2 g; the solvent was 8 g of DMAc, and the boiling point of the solvent was 165° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 25%.

### Comparative Example 4

As described in the detailed description, HNA was selected as the compound monomer. The first product obtained after the acetylation of the first stage was 2 g; the solvent was 8 g of THF, and the boiling point of the solvent was 66° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 6%.

### Comparative Example 5

As described in the detailed description, HNA was selected as the compound monomer. The first product obtained after the acetylation of the first stage was 2 g; the solvent was 8 g of acetone, and the boiling point of the solvent was 56° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 4%.

### Comparative Example 6

As described in the detailed description, HNA was selected as the compound monomer. The first product obtained after the acetylation of the first stage was 2 g; the solvent was 8 g of EA, and the boiling point of the solvent was 77° C. The catalyst in the second stage was imidazole, the catalyst dosage was 10.3 mol % of the total moles of the compound monomer, and the boiling point of the catalyst was 256° C. Finally, through solid-state polymerization at 230° C., the yield was 7%.

### Comparative Example 7

As described in the detailed description, HNA was selected as the compound monomer. The first product obtained after the acetylation of the first stage was 2 g; the solvent was 8 g of DMAc, and the boiling point of the solvent was 165° C. The catalyst in the second stage was pyrrolidine, the catalyst dosage was 10.3 mol % of the total moles of the compound monomer, and the boiling point of the catalyst was 88° C. Finally, through solid-state polymerization at 230° C., the yield was 5%.

### Comparative Example 8

As described in the detailed description, HNA was selected as the compound monomer. The first product obtained after the acetylation of the first stage was 2 g; the solvent was 8 g of DMAc, and the boiling point of the solvent was 165° C. The catalyst in the second stage was 1-methylpyrrolidine, the catalyst dosage was 10.3 mol % of the total moles of the compound monomer, and the boiling point of the catalyst was 80° C. Finally, through solid-state polymerization at 230° C., the yield was 3%.

### Comparative Example 9

As described in the detailed description, HNA was selected as the compound monomer. The first product obtained after the acetylation of the first stage was 2 g; the solvent was 8 g of DMAc, and the boiling point of the solvent was 165° C. The catalyst in the second stage was triethylamine, the catalyst dosage was 10.3 mol % of the total moles of the compound monomer, and the boiling point of the catalyst was 89° C. Finally, through solid-state polymerization at 230° C., the yield was 5%.

### Comparative Example 10

As described in the detailed description, HNA was selected as the compound monomer. The first product obtained after the acetylation of the first stage was 2 g; the solvent was 8 g of DMAc, and the boiling point of the solvent was 165° C. No catalyst was used in the second stage, so no reaction occurred. The yield was 0%.

### Table for Examples and Comparative Examples

TABLE 1

| | Liquid crystal polymer particles | | | | | | | | |
|---|---|---|---|---|---|---|---|---|---|
| | | | | Boiling | | | Thermo- | | |
| | | | | point | | | gravimetric | | |
| | | Boiling point | | of | | Melting | loss at | | |
| | Monomer | of solvent | | catalyst | Yield | point | 1 wt % | D₅₀ | D₉₉ |
| | composition | (° C.) | Catalyst | (° C.) | (%) | (° C.) | (° C.) | (um) | (um) |
| Example 1 | HNA₁₀₀ | DMAc/165 | Imidazole | 256 | 28 | 342 | 524 | 0.19 | 9.1 |
| Example 2 | HNA₈₅ + HBA₁₅ | DMAc/165 | Imidazole | 256 | 18 | 328 | 515 | 0.21 | 8.8 |
| Example 3 | HNA₇₅ + HBA₂₅ | DMAc/165 | Imidazole | 256 | 17 | 315 | 508 | 0.22 | 8.8 |
| Example 4 | HBA₁₀₀ | DMAc/165 | Imidazole | 256 | 29 | 339 | 512 | 0.18 | 8.5 |
| Example 5 | HNA₁₅ + HBA₈₅ | DMAc/165 | Imidazole | 256 | 19 | 323 | 508 | 0.19 | 9 |
| Example 6 | HNA₂₅ + HBA₇₅ | DMAc/165 | Imidazole | 256 | 16 | 310 | 502 | 0.19 | 9.2 |
| Example 7 | HNA₇₅ + HBPA₂₅ | DMAc/165 | Imidazole | 256 | 17 | 307 | 493 | 0.22 | 9.2 |
| Example 8 | HBA₇₅ + HBPA₂₅ | DMAc/165 | Imidazole | 256 | 16 | 304 | 486 | 0.22 | 9.1 |
| Example 9 | HNA₁₀₀ | NMP/202 | Imidazole | 256 | 29 | 341 | 528 | 0.21 | 8.5 |
| Example 10 | HNA₁₀₀ | 3MP/144 | Imidazole | 256 | 21 | 339 | 520 | 0.2 | 9 |
| Example 11 | HNA₁₀₀ | DMAc/165 | 1-Methylimidazole | 198 | 24 | 341 | 522 | 0.18 | 9.2 |
| Example 12 | HNA₁₀₀ | DMAc/165 | 2-Methylimidazole | 268 | 28 | 343 | 521 | 0.18 | 8.7 |
| Example 13 | HNA₁₀₀ | DMAc/165 | 1,2-Dimethylimidazole | 204 | 26 | 341 | 524 | 0.21 | 8.9 |
| Example 14 | HNA₁₀₀ | DMAc/165 | 1,4-diazabicyclo[2.2.2]octane | 175 | 22 | 340 | 523 | 0.23 | 9.3 |
| Comparative | HNA₆₅ + HBA₃₅ | DMAc/165 | Imidazole | 256 | 26 | 267 | 465 | 0.22 | 9.3 |
| Example 1 | | | | | | | | | |
| Comparative | HNA₅₀ + HBA₅₀ | DMAc/165 | Imidazole | 256 | 27 | 248 | 458 | 0.19 | 9.3 |
| Example 2 | | | | | | | | | |
| Comparative | HNA₆₅ + HBPA₃₅ | DMAc/165 | Imidazole | 256 | 25 | 263 | 466 | 0.21 | 8.7 |
| Example 3 | | | | | | | | | |
| Comparative | HNA₁₀₀ | THF/66 | Imidazole | 256 | 6 | 338 | 521 | 0.16 | 8.5 |
| Example 4 | | | | | | | | | |
| Comparative | HNA₁₀₀ | Acetone/56 | Imidazole | 256 | 4 | 338 | 522 | 0.15 | 8.6 |
| Example 5 | | | | | | | | | |
| Comparative | HNA₁₀₀ | EA//77 | Imidazole | 256 | 7 | 339 | 520 | 0.17 | 8.5 |
| Example 6 | | | | | | | | | |
| Comparative | HNA₁₀₀ | DMAc/165 | Pyrrolidine | 88 | 5 | 339 | 523 | 0.2 | 8.8 |
| Example 7 | | | | | | | | | |
| Comparative | HNA₁₀₀ | DMAc/165 | 1-Methylpyrrolidine | 80 | 3 | 339 | 521 | 0.19 | 9 |
| Example 8 | | | | | | | | | |
| Comparative | HNA₁₀₀ | DMAc/165 | Triethylamine | 89 | 5 | 340 | 522 | 0.21 | 9.1 |
| Example 9 | | | | | | | | | |
| Comparative | HNA₁₀₀ | DMAc/165 | — | — | 0 | — | — | — | — |
| Example 10 | | | | | | | | | |

### Example 15

Preparation of polyamic acid: 100 mole % of diamine diphenyl ether (ODA) was added into N,N-dimethylacetamide (DMAc) for complete dissolution. Afterwards. 100 mole % of pyromellitic anhydride (PMDA) was slowly added and stirred for another 6 hours until the dianhydride was dissolved and reacted, and the temperature of the solution was maintained at 25° C. Finally, a polyamic acid solution with a viscosity of 180,000 cps±20,000 cps was obtained.

Polyimide film: The liquid crystal polymer particles of Example 1 were blended into the polyamic acid solution and mixed uniformly, then coated onto the glass in a manner that the addition amount of the liquid crystal polymer particles was 5 wt % of the polyimide film, and then heated in an oven at 80° C. to remove most of the solvent. Next, the solvent was completely removed under the conditions of 170° C./90 min, and finally the temperature was raised under the conditions of 370° C./60 min for high-temperature baking to form a polyimide film. The polyimide film was tested for surface roughness (Sa).

### Example 16

The steps were the same as in Example 15, except that the addition amount of the liquid crystal polymer particles was modified to 40 wt % of the polyimide film.

### Example 17

The steps were the same as in Example 15, except that the addition amount of the liquid crystal polymer particles was modified to 70 wt % of the polyimide film.

### Comparative Example 11

The steps were the same as in Example 15, except that the addition amount of the liquid crystal polymer particles was modified to 80 wt % of the polyimide film.

### Comparative Example 12

The steps were the same as in Example 15, except that the commercial available LF-31P (manufacturing company: ENEOS) was selected as the liquid crystal polymer particles, which had a D50 of 5.4 um; a D95 of 14 um; and a melting point of 319° C. The addition amount of the liquid crystal polymer particles was 5 wt % of the polyimide film.

### Comparative Example 13

The steps were the same as in Comparative Example 12, except that the addition amount of the liquid crystal polymer particles was modified to 50 wt % of the polyimide film.

TABLE 2

| | Polyimide film | | | |
|---|---|---|---|---|
| | | liquid crystal polymer | | Surface |
| | | particles | | roughness |
| | Formulation of | | Addition amount | (Sa) |
| | polyimide | Sample | (wt %) | (um) |
| Example 15 | ODA + PMDA | HNA₁₀₀ | 5 | 0.21 |
| Example 16 | | HNA₁₀₀ | 40 | 0.49 |
| Example 17 | | HNA₁₀₀ | 70 | 0.62 |
| Comparative | | HNA₁₀₀ | 80 | 0.85 |
| Example 11 | | | | |
| Comparative | | LF-31P | 5 | 0.97 |
| Example 12 | | | | |
| Comparative | | LF-31P | 50 | 1.63 |
| Example 13 | | | | |

### Relevant Description of Comparative Examples in Table 1

Comparative Example 1: The compound monomer preferably has more than 75 mol % of HBA or HNA. However, the HNA of Comparative Example 1 is 65 mol %; and the HBA is 35 mol %, neither of which reaches more than 75 mol %, so the melting point of liquid crystal polymer particles does not reach above 300° C., and the thermal cracking temperature when the thermogravimetric loss is 1 wt % does not reach 470° C.
Comparative Example 2: The compound monomer preferably has more than 75 mol % of HBA or HNA. However, the HNA of Comparative Example 2 is 50 mol %; and the HBA is 50 mol %, neither of which reaches more than 75 mol %, so the melting point of liquid crystal polymer particles does not reach above 300° C., and the thermal cracking temperature when the thermogravimetric loss is 1 wt % does not reach 470° C.
Comparative Example 3: The compound monomer preferably has more than 75 mol % of HBA or HNA. However, the HNA of Comparative Example 3 is 65 mol %, which does not reach more than 75 mol %, so the melting point of liquid crystal polymer particles does not reach above 300° C., and the thermal cracking temperature when the thermogravimetric loss is 1 wt % does not reach 470° C.
Comparative Example 4: Since the boiling point of the solvent used in the solvent method needs to be above 100° C. and preferably above 130° C., the boiling point of the solvent in this example is 66° C., which does not reach above 130° C., so the yield of liquid crystal polymer particles does not reach 15%.
Comparative Example 5: Since the boiling point of the solvent used in the solvent method needs to be above 100° C. and preferably above 130° C., the boiling point of the solvent in this example is 56° C., which does not reach above 130° C., so the yield of liquid crystal polymer particles does not reach 15%.
Comparative Example 6: Since the boiling point of the solvent used in the solvent method needs to be above 100° C. and preferably above 130° C., the boiling point of the solvent in this example is 77° C., which does not reach above 130° C., so the yield of liquid crystal polymer particles does not reach 15%.
Comparative Example 7: Since the boiling point of the catalyst used in the solvent method is preferably above 100° C., however, the boiling point of the catalyst in this example is 88° C., which does not reach above 100° C., so the yield of liquid crystal polymer particles does not reach 15%.
Comparative Example 8: Since the boiling point of the catalyst used in the solvent method is preferably above 100° C., however, the boiling point of the catalyst in this example is 80° C., which does not reach above 100° C., so the yield of liquid crystal polymer particles does not reach 15%.
Comparative Example 9: Since the boiling point of the catalyst used in the solvent method is preferably above 100° C., the boiling point of the catalyst in this example is 89° C., which does not reach above 100° C., so the yield of liquid crystal polymer particles does not reach 15%.
Comparative Example 10: Since the boiling point of the catalyst used in the solvent method is preferably above 100° C., no catalyst is used in this example, resulting in no reaction.

### Relevant Description of Comparative Examples in Table 2

Comparative Example 11: In the polyimide film prepared by blending liquid crystal polymer particles with the polyamic acid solution, the content of the liquid crystal polymer particles needs to be 5˜70 wt %. In Comparative Example 11, the content of the liquid crystal polymer particles is 80 wt %, so the surface roughness (Sa) is above 0.8 um.
Comparative Example 12: The liquid crystal polymer of Comparative Example 12 is commercially available LF-31P (manufacturing company: ENEOS) having a D50 of 5.4 um and a D95 of 14 um, which is not within the scope of the present application. Although the addition amount is 5 wt % of the polyimide film, the particle size of the liquid crystal polymer particles is too large, so the surface roughness (Sa) of the polyimide film is above 0.8 um.
Comparative Example 13: The liquid crystal polymer of Comparative Example 13 is commercially available LF-31P (manufacturing company: ENEOS) having a D50 of 5.4 um and a D95 of 14 um, which is not within the scope of the present application. Although the addition amount is 50 wt % of the polyimide film, the particle size of the liquid crystal polymer particles is too large, so the surface roughness (Sa) of the polyimide film is above 0.8 um.

The content of the above specific examples is to illustrate the present disclosure in detail. However, these examples are only for illustration and are not intended to limit the present disclosure. Those skilled in the art will understand that various changes or modifications made to the present disclosure without departing from the scope defined in the appended claims are falling within parts of the present

While the present disclosure has been described by means of specific embodiments, numerous modifications and variations could be made thereto by those skilled in the art without departing from the scope and spirit of the present disclosure set forth in the claims.

What is claimed is:

1. A method for manufacturing a liquid crystal polymer particle, comprising the following steps:
providing a compound monomer having a chemical structural formula of COOH—Ar—OH, wherein Ar is at least one conjugated cyclic structure; adding the compound monomer to a solvent with a boiling point of 100° C. or above, and heating to the boiling point of the solvent for performing an acetylation reaction to obtain a first product; adding a catalyst to the first product to perform a transesterification reaction to obtain a second product; performing solid-state polymerization of the second product at a temperature of 200-250° C. to obtain the liquid crystal polymer particle; wherein,
a particle size distribution of the liquid crystal polymer particle has a cumulative distribution of 50% particle size (D50) of 1.5 um or less, and a cumulative distribution of 99% particle size (D99) of 10 um or less.

2. The method of claim 1, wherein the conjugated cyclic structure is at least one selected from the group consisting of phenyl, biphenyl, naphthyl, anthracenyl, phenanthrenyl, pyrenyl, a polycyclic aromatic and a heterocyclic ring.

3. The method of claim 1, wherein the compound monomer comprises at least 75 mol % of 6-hydroxynaphthalene-2-carboxylic acid (HNA) or 4-hydroxybenzoic acid (HBA), and the liquid crystal polymer particle has a melting point of 300° C. or above and a thermal cracking temperature when a thermogravimetric loss is 1 wt % is 470° C. or above.

4. The method of claim 1, wherein the boiling point of the solvent is 130° C. or above.

5. The method of claim 1, wherein the catalyst is a nitrogen-containing organic catalyst with a boiling point of 100° C. or above.

6. A liquid crystal polymer particle, polymerized from a compound monomer and having a chemical structural formula of 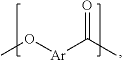
wherein Ar is at least one conjugated cyclic structure; and
a particle size distribution of the liquid crystal polymer particle has a cumulative particle size at 50% (D50) of 1.5 um or less and a cumulative particle size at 99% (D99) of 10 um or less.

7. The liquid crystal polymer particle of claim 6, wherein a chemical structural formula of the compound monomer is COOH—Ar—OH, wherein Ar is at least one conjugated cyclic structure.

8. The liquid crystal polymer particle of claim 6, wherein the conjugated cyclic structure is at least one selected from the group consisting of phenyl, biphenyl, naphthyl, anthracenyl, phenanthrenyl, pyrenyl, a polycyclic aromatic and a heterocyclic ring.

9. A polyimide film, comprising the liquid crystal polymer particle of claim 6, wherein a content of the liquid crystal polymer particle is 5˜70 wt % of the polyimide film, and a surface roughness (Sa) of the polyimide film is 0.8 um or less.
